(19) United States
(12) Patent Application Publication
(10) Pub. No.: US 2022/0044113 A1
(43) Pub. Date: Feb. 10, 2022

(54) Asynchronous Neural Network Systems

(71) Applicant: Western Digital Technologies, Inc., San Jose, CA (US)

(72) Inventors: Haoyu Wu, Sunnyvale, CA (US); Qian Zhong, Fremont, CA (US); Toshiki Hirano, San Jose, CA (US)

(21) Appl. No.: 17/178,809

(22) Filed: Feb. 18, 2021

Related U.S. Application Data
(60) Provisional application No. 63/063,904, filed on Aug. 10, 2020.

(51) Int. Cl. G06N 3/08; G06K 9/62

(52) U.S. Cl. CPC G06N 3/08; G06K 9/6232

(57) ABSTRACT

A device configured for processing time-series data within an asynchronous neural network may include a processor configured to execute the neural network. The device may further include a multi-step convolution pathway wherein the output of at least one step includes one or more feature maps. Additionally, a multi-step upsampling pathway with steps having corresponding convolution step inputs is included. The device further utilizes feature map data from at least one step of the multi-step convolution process as input data in at least one corresponding step of the upsampling process. The device also includes an inference frequency controller to receive input data and transmit a processing frequency signal to the neural network. The neural network can then generate feature maps at a reduced frequency within the multi-step convolution pathway, and utilize previously processed feature maps as input data within the multi-step upsampling pathway until a subsequent feature map is generated.

### PRIORITY

This application claims the benefit of and priority to U.S. Provisional Application No. 63/063,904, filed Aug. 10, 2020, the entirety of which is incorporated in its entirety herein.

### FIELD

The present disclosure relates to neural network processing. More particularly, the present disclosure technically relates to generating inferences of time-series data from asynchronously processed neural networks.

### BACKGROUND

As technology has grown over the last decade, the growth of time-series data such as video content has increased dramatically. This increase in time-series data has generated a greater demand for automatic classification. In response, neural networks and other artificial intelligence methods have been increasingly utilized to generate automatic classifications, specific detections, and segmentations. In the case of video processing, computer vision trends have progressively focused on object detection, image classification, and other segmentation tasks to parse semantic meaning from video content.

However, as time-series data and the neural networks used to analyze them have increased in size and complexity, a higher computational demand is created. More data to process requires more processing power to compile all of the data. Likewise, more complex neural networks require more processing power to parse the data. Traditional methods of handling these problems include trading a decrease in output accuracy for increased processing speed, or conversely, increasing the output accuracy for a decrease in processing speed. The current state of the art suggests that increasing both output accuracy and speed is achieved through providing an increase in computational power. However, systems that utilize less computational power while yielding similarly accurate results are desired.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of the generation of an inference map image from multiple video still images in accordance with an embodiment of the disclosure;

FIG. 2 is a conceptual illustration of a neural network in accordance with an embodiment of the disclosure;

FIG. 3 is a conceptual illustration of a convolution process in accordance with an embodiment of the disclosure;

FIG. 4A is an illustrative visual example of a convolution process in accordance with an embodiment of the disclosure;

FIG. 4B is an illustrative numerical example of a convolution process in accordance with an embodiment of the disclosure;

FIG. 5A is an illustrative visual example of an upsampling process in accordance with an embodiment of the disclosure;

FIG. 5B is an illustrative numerical example of an upsampling process in accordance with an embodiment of the disclosure;

FIG. 5C is an illustrative numerical example of a second upsampling process in accordance with an embodiment of the disclosure;

FIG. 5D is an illustrative numerical example of an upsampling process utilizing a lateral connection in accordance with an embodiment of the disclosure;

FIG. 6 is a conceptual illustration of a feature pyramid network in accordance with an embodiment of the disclosure;

FIG. 7 is an illustrative comparison between image classification, object detection, and instance segmentation in accordance with an embodiment of the disclosure;

FIG. 8 is a conceptual diagram of an asynchronous neural network system in accordance with an embodiment of the disclosure;

FIG. 9 is a schematic block diagram of a host-computing device capable of utilizing asynchronous neural networks in accordance with an embodiment of the disclosure;

FIG. 10 is a flowchart depicting a process for utilizing a feature map data cache in an asynchronous neural network system in accordance with an embodiment of the disclosure; and

FIG. 11 is a flowchart depicting the processing of input data by an inference frequency controller within an asynchronous neural network in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, systems and methods are discussed herein that describe processes for creating an asynchronous neural network system that utilizes fewer computational cycles while yielding similarly accurate output results compared to traditional neural networks. Specifically, many embodiments of the disclosure generate a multi-stage neural network comprising a convolution pathway and an upsampling pathway wherein each stage of the neural network corresponds to a step within the convolution pathway that outputs data through a lateral connection to an input step of the upsampling pathway. An inference frequency controller receives and processes a plurality of data and generates one or more signals that direct the neural network to reduce the processing of input data within one or more stages. This results in asynchronous processing between multiple stages within the neural network. As additional input data is processed, stages of the neural network that have a reduced processing frequency still require one or more feature map inputs to pass through the lateral connections. Various embodiments do not process additional data through the neural network, but instead store and recall previously processed feature map data from a feature map cache data store. The stored and recalled feature map data can continue to be utilized by the lower frequency stages in the neural network until that stage is fully activated and processes a new input data source.

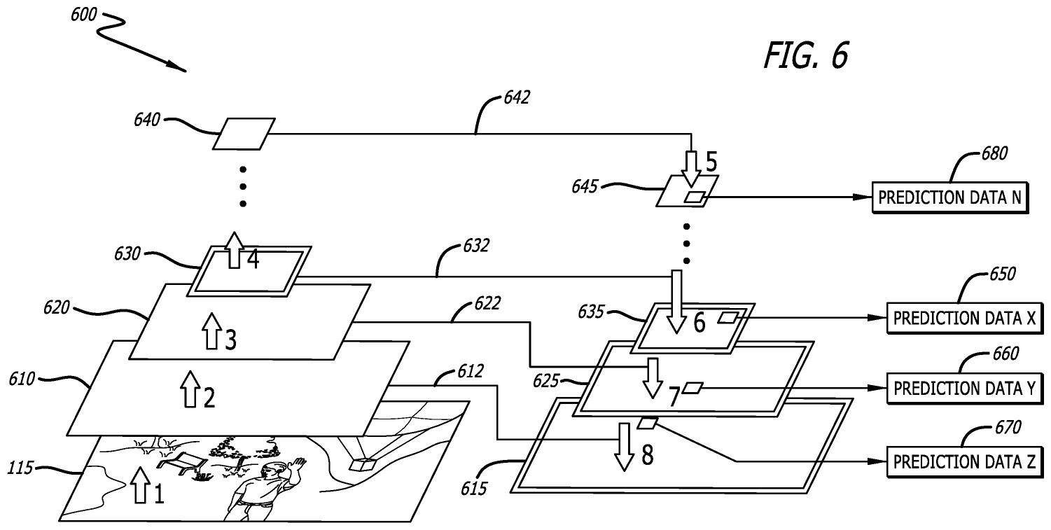

In a number of embodiments, the neural network utilizes a feature pyramid network which is often more computationally intensive than a traditional neural network as more steps are required to get sufficiently accurate output. However, neural networks like the feature pyramid network comprise various points in which processing is not always needed for each piece of input data. As will be discussed in more detail within FIG. 6, a multi-stage network may be able to split the processing of each input data set into various parts that can operate at different frequencies. By way of example and not limitation, video content input data may require processing on each frame such that 30 frames (or more depending on the native frame rate) are required to be processed each second.

Furthermore, embodiments of the present disclosure can direct some steps within the multi-stage neural network such that one stage (typically the stage configured for tracking smaller and faster moving objects) operates at a full frequency (30 frames or more per second for example), while another stage (typically the stage that tracks large, or slower-moving objects) is directed to only process every third image (10 frames per second, or equivalent fraction). Subsequently, when the multi-stage neural network attempts to complete processing of an image, the feature map data associated with the lower frequency stage is needed. However, instead of processing the input image through the neural network to generate new feature map data, embodiments of the present disclosure recall and use previously generated feature map data created from previous images within the video. Thus, the previously stored feature map data is merged with the current images to create an output data set, including an inference map image such as object classification or segmentation map.

Embodiments of the present disclosure can be utilized in a variety of fields including general video analytics, facial recognition, object segmentation, object recognition, autonomous driving, traffic flow detection, drone navigation/operation, stock counting, inventory control, and other automation-based tasks that generate time-series based data. The use of these embodiments can result in fewer required computational resources to produce similarly accurate results compared to a traditional synchronous neural network. In this way, more deployment options may become available as computational resources increase and become more readily available on smaller electronic devices.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, a field-programmable gate array (“FPGA”) or other discrete components. A function may also be implemented in programmable hardware devices such as via field programmable gate arrays, programmable array logic, programmable logic devices, or the like.

“Neural network” refers to any logic, circuitry, component, chip, die, package, module, system, sub-system, or computing system configured to perform tasks by imitating biological neural networks of people or animals. Neural network, as used herein, may also be referred to as an artificial neural network (ANN). Examples of neural networks that may be used with various embodiments of the disclosed solution include, but are not limited to, convolutional neural networks, feed forward neural networks, radial basis neural network, recurrent neural networks, modular neural networks, and the like. Certain neural networks may be designed for specific tasks such as object detection, natural language processing (NLP), natural language generation (NLG), and the like. Examples of neural networks suitable for object detection include, but are not limited to, Region-based Convolutional Neural Network (RCNN), Spatial Pyramid Pooling (SPP-net), Fast Region-based Convolutional Neural Network (Fast R-CNN), Faster Region-based Convolutional Neural Network (Faster R-CNN), You Only Look Once (YOLO), Single Shot Detector (SSD), and the like.

A neural network may include both the logic, software, firmware, and/or circuitry for implementing the neural network as well as the data and metadata for operating the neural network. One or more of these components for a neural network may be embodied in one or more of a variety of repositories, including in one or more files, databases, folders, or the like. The neural network used with embodiments disclosed herein may employ one or more of a variety of learning models including, but not limited to, supervised learning, unsupervised learning, and reinforcement learning. These learning models may employ various backpropagation techniques.

Functions or other computer-based instructions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions, logics and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions, logics, and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

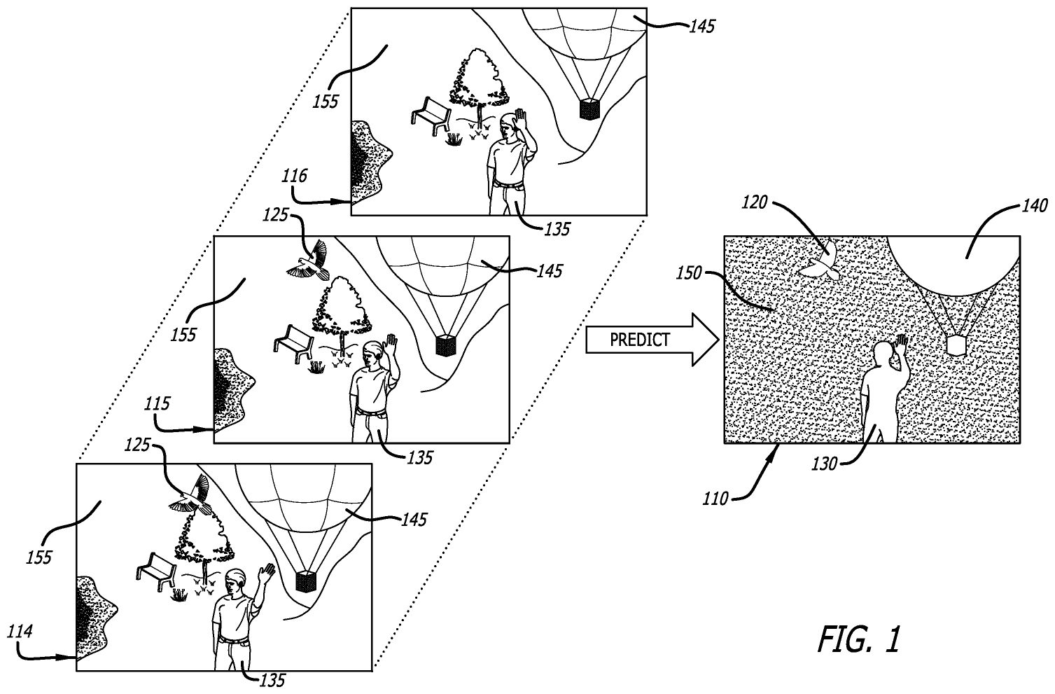

Referring to FIG. 1, a conceptual illustration of the generation of an inference map image 110 from multiple video still images 115, 116, 117 in accordance with an embodiment of the disclosure is shown. As discussed above, large portions of time-series data currently submitted for analytics processing include video content. Video content often comprises a series of still images within a container or wrapper format that describes how different elements of data and metadata coexist within a specific computer file. In many embodiments, a video file comprising video content submitted for analytics processing can be analyzed one frame at a time. However, because many video frames share similar elements with neighboring frames, the processing of each video frame can additionally examine adjacent frames to capture more information.

FIG. 1 illustrates a conceptual example of this process wherein a still frame 115 (also described herein as an image) from a video source is processed to generate an inference map image 110. The process of generating the inference map image 110 utilizes not just the main still frame 115, but also a preceding adjacent frame 114 and a successive adjacent frame 116. In certain embodiments, the preceding adjacent frame 114 and successive adjacent frame 116 can be the exact previous and next frame in series. In further embodiments, the preceding adjacent frame 114 and successive adjacent frame 116 can be keyframes within a compressed video stream. In still further embodiments, adjacent frames 114, 116 can be generated from other data within the video file.

A neural network system may be established to generate an inference map image 110 for each frame of available video within a video file which can then be further processed for various tasks such as, but not limited to, object detection, motion detection, classification, etc. One method a system may accomplish these tasks is to classify groups of pixels within an image as belonging to a similar object. By way of example and not limitation, the inference map image 110 of FIG. 1 has created grouped features 120, 130, 140 (i.e. segmentations) that correspond to a bird 125, person 135, and hot-air balloon 145 which are separate from a background 150.

As will be discussed in more detail below, specific types of neural network processing of time-series data like video content can differentiate between fast-moving and slower-moving items (i.e. features) within the data. For example, the video frames 114, 115, 116 contain a general background 155 and three moving subjects: the bird 125, the person 135, and the hot-air balloon 145. For purposes of the current discussion, the bird 125 can be considered to be moving faster than the person 135 waving, who is moving faster within the video frames 114, 115, 116 than the hot-air balloon 145. Specifically, the bird 125 moves fast enough to fly out of frame by the success adjacent frame 116. The person 135 moves their waving arm throughout the three frames 114, 115, 116 while the hot-air balloon 145 barely moves at all. In a variety of embodiments, based on these differences between the three frames 114, 115, 116, the inference map image 110 may be generated that further classifies each grouped feature 120, 130, 140 as comprising various speeds. As will be discussed in more detail below, this type of information can be utilized to determine when a particular frame, portion of a frame, or any time-series data can be processed at a slower rate as slower-moving, or larger objects tend to change less frequently between frames. In this case, based on the information derived from the adjacent frames 114, 116, a prediction can be made that the hot-air balloon 145 (and respective grouped feature 140) will not significantly move in a subsequently analyzed frame.

As those skilled in the art will recognize, the input and output of neural network processing such as the video files discussed above will typically be formatted as a series of numerical representation of individual pixels that are translated into binary for storage and processing. The images within FIG. 1 are for conceptual understanding purposes and are not to be limiting to the actual inputs and outputs utilized within the current disclosure.

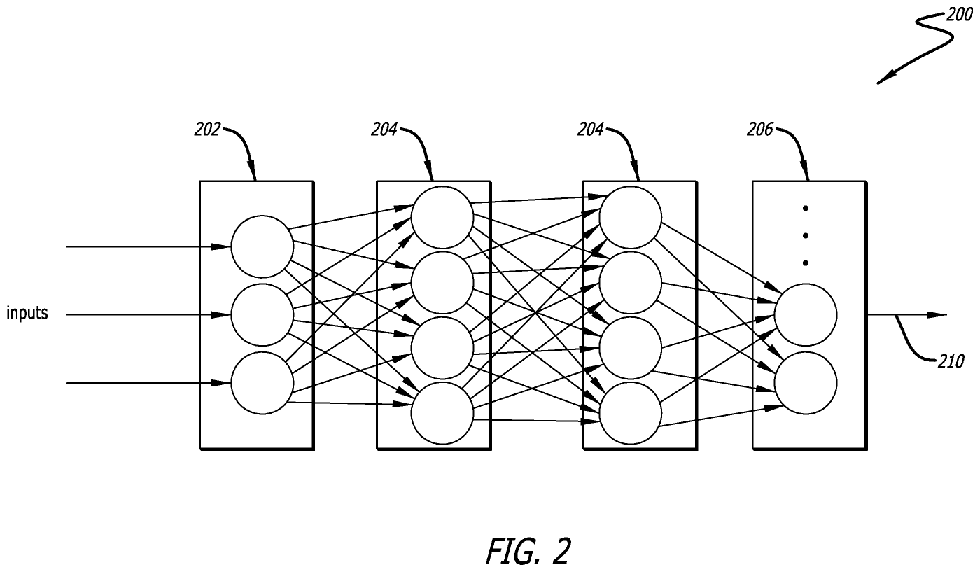

Referring to FIG. 2, is a conceptual illustration of a neural network in accordance with an embodiment of the disclosure is shown. At a high level, the neural network 200 comprises an input layer 202, two or more hidden layers 204, and an output layer 206. The neural network 200 comprises a collection of connected units or nodes called artificial neurons which loosely model the neurons in a biological brain. Each connection, like the synapses in a biological brain, can transmit a signal from one artificial neuron to another. An artificial neuron that receives a signal can process the signal and then trigger additional artificial neurons within the next layer of the neural network. As those skilled in the art will recognize, the neural network depicted in FIG. 2 is shown as an illustrative example and various embodiments may comprise neural networks that can accept more than one type input and can provide more than one type of output.

In a typical embodiment, the signal at a connection between artificial neurons is a real number, and the output of each artificial neuron is computed by some non-linear function (called an activation function) of the sum of the artificial neuron's inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals propagate from the first layer (the input layer 202), to the last layer (the output layer 206), possibly after traversing one or more intermediate layers, called hidden layers 204.

The inputs to a neural network may vary depending on the problem being addressed. In object detection, the inputs may be data representing pixel values for certain pixels within an image or frame. In one embodiment the neural network 200 comprises a series of hidden layers in which each neuron is fully connected to neurons of the next layer. The neural network 200 may utilize an activation function such as sigmoid or a rectified linear unit (ReLU), for example. The last layer in the neural network may implement a regression function such as SoftMax regression to produce the classified or predicted classifications for object detection as output 210. In further embodiments a sigmoid function can be used and position prediction may need raw output transformation into linear and/or non-linear coordinates.

In certain embodiments, the neural network 200 is trained prior to deployment and to conserve operational resources. However, some embodiments may utilize ongoing training of the neural network 200 especially when operational resource constraints such as die area and performance are less critical. As will be discussed in more detail below, the neural networks in many embodiments will process video frames through a series of downsamplings (e.g. convolutions, pooling, etc.) and upsamplings (i.e. expansions) to generate an inference map similar to the inference map image 110 depicted in FIG. 1.

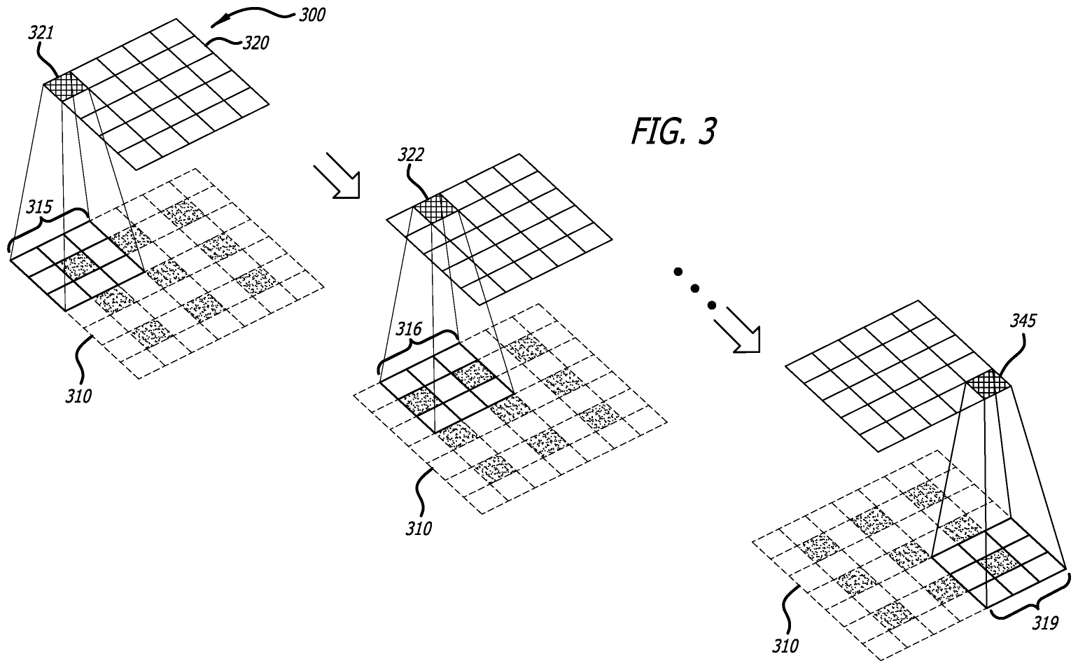

Referring to FIG. 3, a conceptual illustration of a convolution process 300 in accordance with an embodiment of the disclosure is shown. In a number of time-series neural networks, input data is processed through one or more convolution layers. Convolution is a process of adding each element of an image to its local neighbors, weighted by a kernel. Often, this type of linear operation is utilized within the neural network instead of a traditional matrix multiplication process. As an illustrative example, FIG. 3 depicts a simplified convolution process 300 on an array of pixels within a still image 310 to generate a feature map 320.

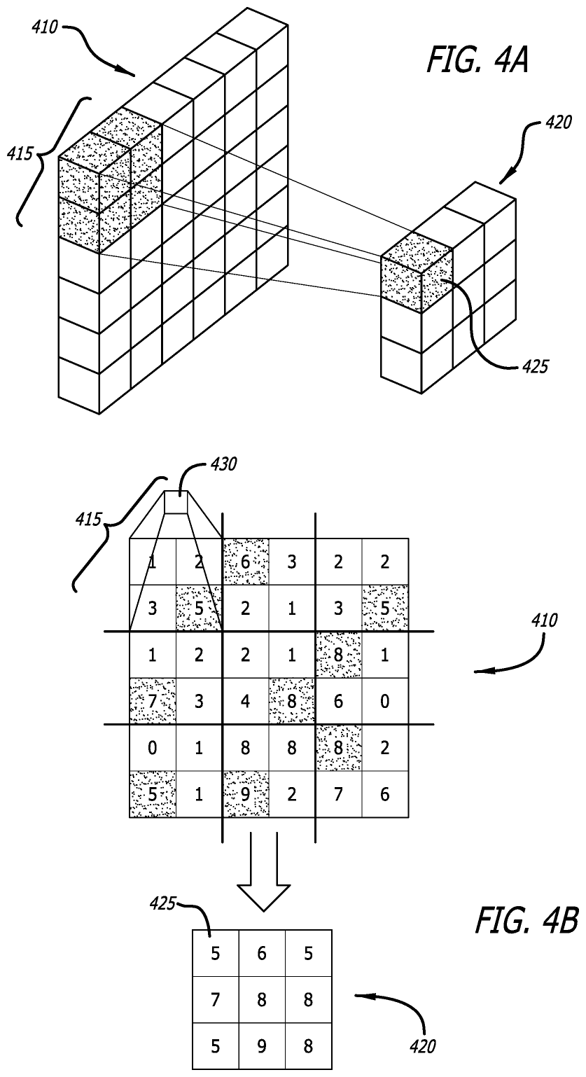

The still image 310 depicted in FIG. 3 is comprised of forty-nine pixels in a seven by seven array. As those skilled in the art will recognize, any image size may be processed in this manner and the size depicted in this figure is minimized to better convey the overall process utilized. In the first step within the process 300, a first portion 315 of the still image 310 is processed. The first portion 315 comprises a three by three array of pixels. This first portion is processed through a filter to generate an output pixel 321 within the feature map 320. A filter can be understood to be another array, matrix, or mathematical operation that can be processed on the portion being processed. Typically, the filter can be presented as a matrix similar to the portion being processed and generates the output feature map portion via matrix multiplication or similar operation. In some embodiments, a filter may be a heuristic rule that applies to the portion being processed. An example of such a mathematical process is shown in more detail within the discussion of FIG. 4.

Once the first portion 315 of the still image 310 has been processed by the filter to produce an output pixel 321 within the feature map 320, the process 300 can move to the next step which analyzes a second (or next) portion 316 of the still image 310. This second portion 316 is again processed through a filter to generate a second output pixel 322 within the feature map. This method is similar to the method utilized to generate the first output pixel 321. The process 300 continues in a similar fashion until the last portion 319 of the still image 310 is processed by the filter to generate a last output pixel 345. Although output pixels 321, 322, 345 are described as pixels similar to pixels in a still image being processed such as still image 310, it should be understood that the output pixels 321, 322, 345 as well as the pixels within the still image 310 are all numerical values stored within some data structure and are only depicted within FIG. 3 to convey a visual understanding of how the data is processed.

In fact, as those skilled in the art will understand, video still images often have multiple channels which correspond to various base colors (red, green, blue, etc.) and can even have additional channels (i.e., layers, dimensions, etc.). In these cases, the convolution process 300 can be repeated for each channel within a still image 310 to create multiple feature maps 320 for each available channel. In various embodiment, the filter that processes the still image 310 may also be dimensionally matched with the video input such that all channels are processed at once through a matching multi-dimensional filter that produces a single output pixel 321, 322, 345 like those depicted in FIG. 3, but may also produce a multi-dimensional feature map. In additional embodiments, convolution methods such as depthwise separable convolutions may be utilized when multiple channels are to be processed.

Referring to FIG. 4A, an illustrative visual example of a convolution process in accordance with an embodiment of the disclosure is shown. As discussed above, the convolution process can take an input set of data, process that data through a filter, and generate an output that can be smaller than the input data. In various embodiments, padding may be added during the processing to generate output that is similar or larger than the input data. An example visual representation of a data block 410 highlights this processing of data from a first form to a second form. Broadly, the data block 410 comprises a first portion 415 which is processed through a filter to generate a first output feature map data block 425 within the output feature map 420. The original data block 410 is shown as a six by six block while the output feature map 420 is shown as a three by three block.

Referring to FIG. 4B, an illustrative numerical example of a convolution process in accordance with an embodiment of the disclosure is shown. The same example data block 410 is shown numerically processed into an output feature map 420. The first portion 415 is a two by two numerical matrix in the upper left corner of the data block 410. The convolution process examines those first portion 415 matrix values through a filter 430. The filter in the example depicted in FIG. 4B applies a heuristic rule to output the maximum value within the processed portion. Therefore, the first portion 415 results in a feature map data block 425 value of five. As can be seen in FIG. 4B, the remaining two by two sub-matrices within the data block 410 comprise at least one highlighted value that corresponds to the maximum value within that matrix and is thus the resultant feature map block output within the feature map 420.

It is noted that the convolution process within FIG. 4B was applied every two data blocks (or sub-matrix) whereas the convolution process 300 within FIG. 3 progressed pixel by pixel. This highlights that convolution processes can progress at various units, within various dimensions, and with various sizes. The convolution processes depicted within FIGS. 3, 4A and 4B are meant to be illustrative and not limiting. Indeed, as input data becomes larger and more complex, the filters applied to the input data can also become more complex to create output feature maps that can indicate various aspects of the input data. These aspects can include, but are not limited to, straight lines, edges, curves, color changes, etc. As will be described in more detail within the discussion of FIG. 6, output feature maps can themselves be processed through additional convolution process with further filters to generate more indications of useful aspects, features, and data. In a number of embodiments, after one or more downsampling processes have occurred, there may be an expansion or upsampling of the data to generate more useful information. The upsampling process is described in more detail below.

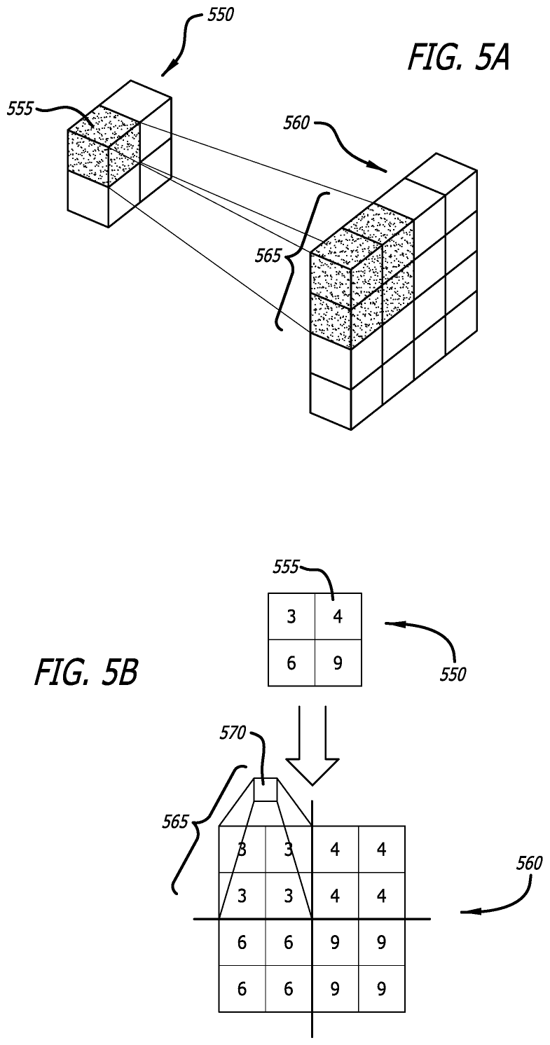

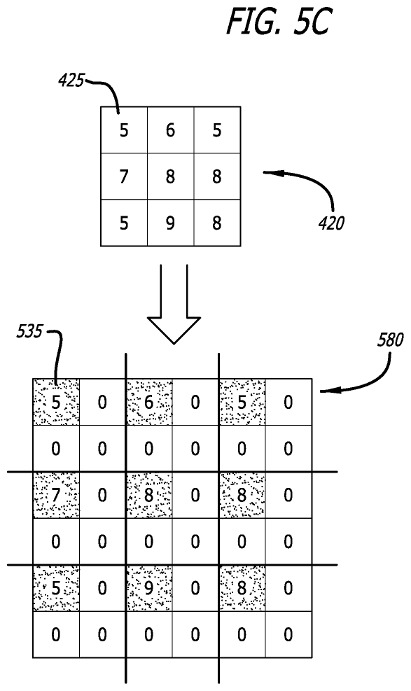

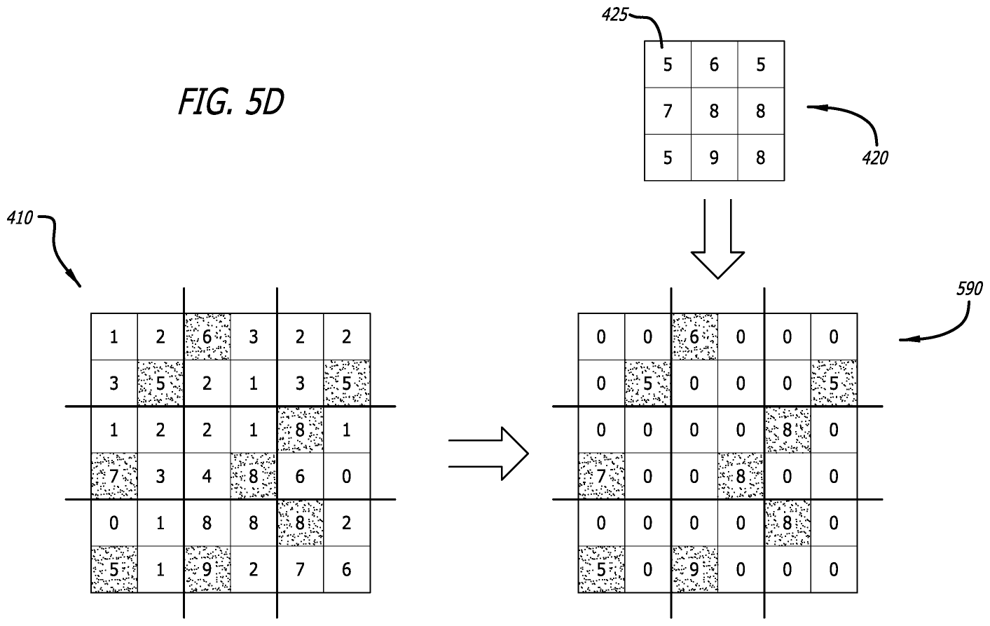

Referring to FIG. 5A, an illustrative visual example of an upsampling process in accordance with an embodiment of the disclosure is shown. The process of upsampling is similar to the convolution process wherein an input is processed through a filter to generate an output. The differences are that upsampling typically has an output that is generally larger than the input. For example, the upsampling process depicted in FIGS. 5A and 5B depict a two by two numerical input matrix 550 being processed through a filter 570 to generate a four by four output matrix 560.

Specifically, referring to FIG. 5B, an illustrative numerical example of an upsampling process in accordance with an embodiment of the disclosure is shown. a first input block 555 of the input matrix 550 is processed through a filter 570 to generate a first output matrix block 565 within the output matrix 560. As will be recognized by those skilled in the art, the filter 570 of FIG. 5B is a “nearest neighbor” filter. This process is shown numerically through the example input block 555 which has a value of four being processed through a filter 570 that results in all values within the output matrix block 565 to contain the same value of four. The remaining input blocks within the input matrix 550 also follow this filter 570 to generate similar output blocks within the output matrix 560 that “expand” or copy their values to all blocks within their respective output matrix block.

Referring to FIG. 5C, an illustrative numerical example of a second upsampling process in accordance with an embodiment of the disclosure is shown. Although the upsampling process depicted in FIGS. 5A-5B utilize a filter that expands or applies the input value as output values to each respective output block, those skilled in the art will recognize that a variety of upsampling filters may be used including those filters that can apply their values to only partial locations within the output matrix.

As depicted in FIG. 5C, many embodiments of an upsampling process may pass the input value along to only one location within the respective output matrix block, padding the remaining locations with another value. In the case of the embodiment depicted in FIG. 5C, the other value utilized is a zero which those skilled in the art will recognize as a “bed of nails” filter. Specifically, the input value of the feature map data block 425 is transferred into the respective location 535 within the output data block 580. In these embodiments, the upsampling process will not be able to apply input values to any variable location within an output matrix block based on the original input data as that information was lost during the convolution process. Thus, as in the embodiment depicted in FIG. 5C, each input value from the input block (i.e. feature map) 420 can only be placed in the upper left pixel of the output data block 580.

In further embodiments however, upsampling processes may acquire a second input that allows for location data (often referred to as “pooling” data) to be utilized in order to better generate an output matrix block (via “unpooling”) that better resembles or otherwise is more closely associated with the original input data compared to a static, non-variable filter. This type of processing is conceptually illustrated in FIG. 5D, which is an illustrative numerical example of an upsampling process utilizing a lateral connection in accordance with an embodiment of the disclosure.

The process for utilizing lateral connections can be similar to the upsampling process depicted in FIG. 5C wherein an input block (i.e. feature map) 420 is processed through a filter and upsampled into a larger unpooled output data block 590. However, instead of placing the input value (i.e. feature map data block) 425 and all other data blocks into the upper right corner as in FIG. 5C, another source of data can decide where the value goes. Specifically, the input data block 410 from the convolution processing earlier in the process can be utilized to provide positional information about the data. The input block 410 can be “pooled” in that the input block 410 stores the location of the originally selected maximum value from FIG. 4B. Then, utilizing a lateral connection to the upsampling process, the pooled data can be unpooled to indicate to the process (or filter) where the values in the input block (i.e. feature map) should be placed within each block of the unpooled output data block 590. Thus, the use of lateral connections can provide additional information for upsampling processing that would otherwise be unavailable, potentially reducing computational accuracy.

In additional embodiments, one feature map may have a higher resolution than a second feature map during a merge process. The lower resolution feature map may undergo an upsampling process as detailed above. However, once upsampled, the merge between the feature maps can occur utilizing one or more methods. By way of example, a concatenation may occur as both feature maps may share the same resolution. In these instances, the number of output channels after concatenation equals the sum of the number of the two input sources. In further embodiments, the merge process may attempt to add two or more feature maps. However, the feature maps may have differing numbers of associated channels, which may be resolved by processing at least one feature map through an additional downsampling (such as a 1×1 convolution). Utilizing data from a convolution process within an upsampling process is described in more detail within the discussion of FIG. 6.

Referring to FIG. 6, a conceptual illustration of a feature pyramid network 600 in accordance with an embodiment of the disclosure is shown. As described above, any type of time-series data can be processed by the processes and methods described herein. However, in order to conceptually illustrate embodiments of the disclosure, the example depicted in FIG. 6 utilizes video content (specifically a still image gathered from video content input) for processing. Generally speaking, the feature pyramid network 600 takes an input image 115 (such as the video frame from FIG. 1) and processes the image through a series of two “pathways.” The first pathway is a “convolution and pooling pathway” which comprises multiple downsampling steps (1-4). This pathway is also known as a “bottom-up” pathway as the feature pyramid can conceptually be understood as working from a bottom input image up through a series of convolution filters. Conversely, the second pathway is known as an “upsampling pathway” which processes the input data from the convolution pathway through a series of upsampling steps (5-8). This pathway is also known as a “top-down” pathway similarly because it can be visualized as taking the output of the bottom-up process and pushing it down through a series of upsampling filters until the final conversion and desired output is reached.

The feature pyramid network 600 can be configured to help detect objects in different scales within an image (and video input by extension). Further configuration can provide feature extraction with increased accuracy and speed compared to alternative neural network systems. The bottom-up pathway comprises a series of convolution networks for feature extraction. As the convolution processing continues, the spatial resolution decreases, while higher level structures are better detected, and semantic value increases. The use of the top-down pathway allows for the generation of data corresponding to higher resolution layers from an initial semantic rich layer.

While layers reconstructed in the top-down pathway are semantically rich, the locations of any detected objects within the layers are imprecise due to the previous processing. However, additional information can be added through the use of lateral connections 612, 622, 632 between a bottom-up layer to a corresponding top-down layer. A data pass layer 642 can pass the data from the last layer from the “bottom-up” path to the first layer of the “top-down” path. These lateral connections 612, 622, 632 can help the feature pyramid network 600 generate output that better predicts locations of objects within the input image 115. In certain embodiments, these lateral connections 612, 622, 632 can also be utilized as skip connections (i.e., “residual connections”) for training purposes.

Additionally, the relationship between a step within the convolution pathway, the lateral connection output from that convolution step and the corresponding input within the upsampling step within the upsampling pathway can be considered a “stage” within the neural network. For example, within the embodiment depicted in FIG. 6, the first feature map layer 610, lateral connection 612 and last upsampling output layer 615 can be considered a stage. Another stage can be the second feature map layer 620, the output lateral connection 622, and the penultimate upsampling output layer 625. Likewise, the other feature map layers 630, 640 of the convolution steps (3, 4) within the convolution pathway and feature map output lateral connection 632 along with the remaining upsampling output layers 635, 645 within the upsampling pathway can each be considered a respective stage. The feature pyramid network 600 then, can be classified and understood as a “multi-stage” neural network. As will be discussed later, each stage within the multi-stage network can be configured to process images at different frequencies. Therefore, a first stage (610, 612, 615) may operate at a higher frequency than another later stage (640, 645). The differences within the frequency of operations performed between these various stages create the asynchronous nature of the asynchronous neural network.

The feature pyramid network of FIG. 6 receives an input image 115 and processes it through one or more convolution filters to generate a first feature map layer 610. The first feature map layer 610 is then itself processed through one or more convolution filters to generate a second feature map layer 620 which is itself further processed through more convolution filters to obtain a third feature map layer 630. As more feature maps are generated, the resolution of the feature maps being processed is reduced, while the semantic value of each feature map increases. It should also be understood that while each step within the feature pyramid network 600 described within FIG. 6 is associated with a single feature map output or upsampling layer output, an actual feature pyramid network may process any number of feature maps per input image and that the number of generated feature maps (and associated upsamplings) can increasingly scale as further layers within the bottom-up process are generated. In certain embodiments, a single input image can generate an unbound number of feature maps and associated upsamplings during the bottom-up and top-down processes. The number of feature maps generated per input data is limited only by computing power available or design based on the desired application.

The feature pyramid network 600 can continue the convolution process until a final feature map layer 640 is generated. In some embodiments, the final feature map layer 640 may only be a single pixel or value. From there, the top-down process can begin by utilizing a first lateral connection to transfer a final feature map layer 640 for upsampling to generate a first upsampling output layer 645. At this stage, it is possible for some prediction data N 680 to be generated relating to some detection within the first upsampling output layer 645. Similar to the bottom-up process, the top-down process can continue processing the first upsampling output layer 645 through more upsampling processes to generate a second upsampling output layer 635 which is also input into another upsampling process to generate a third upsampling output layer 625. In a number of embodiments, this process continues until the final upsampling output layer 615 is the same, or similar size as the input image 115.

However, as discussed above, utilizing upsampling processing alone will not generate accurate location prediction data for detected objects within the input image 115. Therefore, at each step (5-8) within the upsampling process, a lateral connection 612, 622, 632 can be utilized to add location or other data that was otherwise lost during the bottom-up processing. By way of example and not limitation, a value that is being upsampled may utilize location data received from a lateral connection to determine which location within the upsampling output to place the value instead of assigning an arbitrary (and potentially incorrect) location. As each input image has feature maps generated during the bottom-up processing, each step (5-8) within the top-down processing can have a corresponding feature map to draw data from through their respective lateral connection.

With this feature pyramid network, recognizing patterns in data at different scales is more easily achieved. With input images from video content, this can yield the ability to recognize objects at vastly different scales within the input video/still images. As the input is processed in the top-down steps (5-8), the output becomes more spatially accurate. It will be appreciated, however, that this property may be used to avoid certain processing steps depending on the needs of the current application. For example, the input image 115 comprises three main objects that can be recognized during processing including a bird, a person, and a hot-air balloon. The hot-air balloon is a larger, and slower moving object within the input video. Therefore, earlier prediction data output X 650 of the top-down processing, which is semantically rich, but spatially coarser, could still be useful for recognizing the hot-air balloon. Likewise, while some motion exists within the input image 115 between adjacent frames from the person waving, the relative motion of the entire person is not extreme. Therefore, before the upsampling process is entirely completed, a further prediction data output Y 660 may be generated to produce recognition data related to average or moderate moving objects within an input image 115. Finally, the bird within the input image 115 is moving relatively fast and is only in the picture for a few frames. This relatively fast-moving object will likely not have much data available from adjacent frames and may thus require full top-down processing to generate accurate prediction data Z 670.

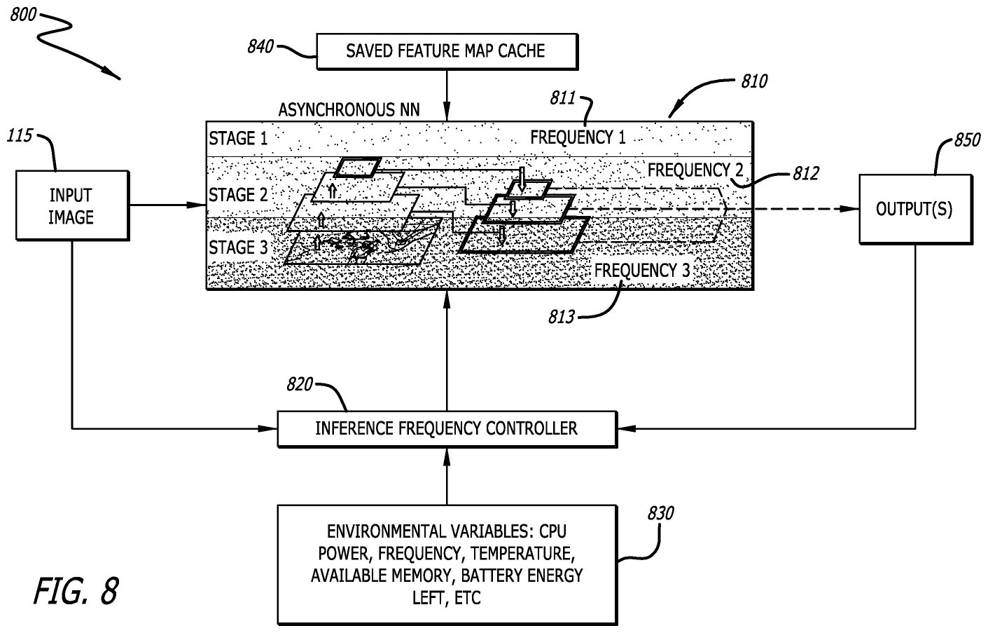

By utilizing prediction data outputs 650, 660, 680 that are earlier within the top-down processing, the generation of desired data may occur earlier, requiring fewer processing operations and less computational power, saving computing resources. The decision to utilize earlier prediction outputs 650, 660, 680 can be based on the desired application and/or the type of input source material. As will be discussed in more detail in FIGS. 8-11, embodiments of the present disclosure can further save computing resources and reduce the overall processing needed by reducing the amount of feature maps generated within the bottom-up processing and providing cached or previously generated feature map data to the upsampling processes in the top-down steps (5-8). Utilizing these variable speeds can allow for reduced processing cycles and sufficiently accurate output, especially for prediction data associated with slower moving objects that do not vary greatly between frames of the input content video.

It will be recognized by those skilled in the art that each convolution and/or upsampling step (5-8) depicted in FIG. 6 can include multiple sub-steps or other operations that can represent a single layer within a neural network, and that each step (1-8) within the feature pyramid network 600 can be processed within a neural network as such and that FIG. 6 is shown to conceptually explain the underlying process within those neural networks. Furthermore, various embodiments can utilize additional convolution or other similar operations within the top-down process to merge elements of the upsampling outputs together. For example, each color channel (red, green, blue) may be processed separately during the bottom-up process but then be merged back together during one or more steps of the top-down process. In further embodiments, these additional merging processes may also receive or utilize feature map data received from one of the lateral connections 612, 622, 632.

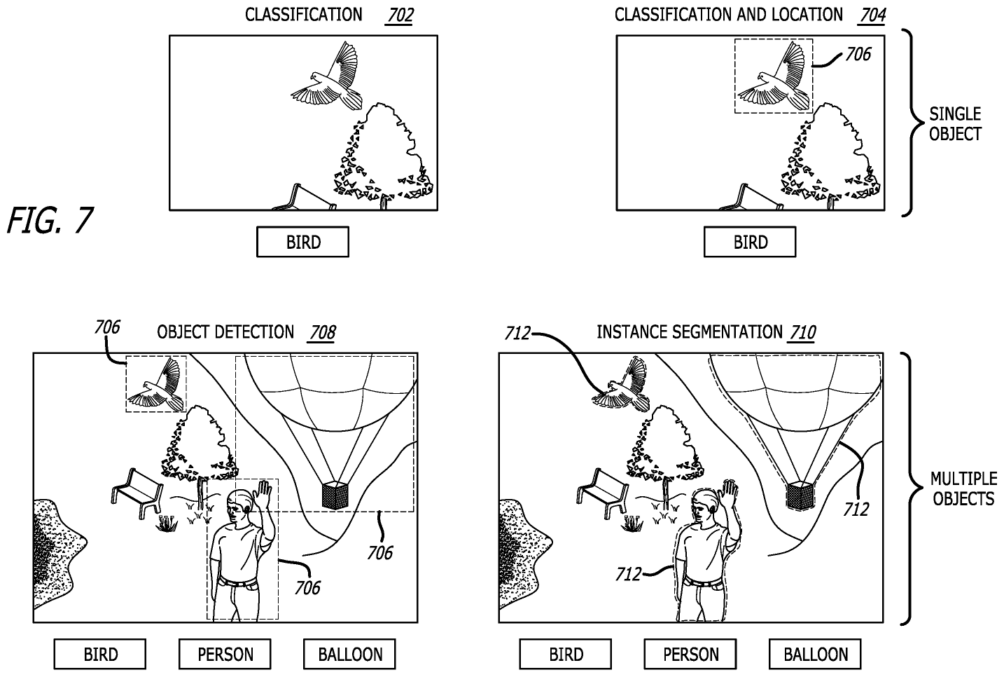

Referring to FIG. 7, an illustrative comparison between image classification, object detection, and instance segmentation in accordance with an embodiment of the disclosure is shown. While discussions and illustrations above have referenced utilizing embodiments of the present disclosure for object detection within an input image or input video content, it should be understood that a variety of data classification/prediction data may be generated based on the feature pyramid network as described in FIG. 6.

For example, when a single object is in an image, a classification model 702 may be utilized to identify what object is in the image. For instance, the classification model 702 identifies that a bird is in the image. In addition to the classification model 702, a classification and localization model 704 may be utilized to classify and identify the location of the bird within the image with a bounding box 706. When multiple objects are present within an image, an object detection model 708 may be utilized. The object detection model 708 can utilize bounding boxes to classify and locate the position of the different objects within the image. An instance segmentation model 710 can detect each major object of an image, its localization, and its precise segmentation by pixel with a segmentation region 712. The inference map image 110 of FIG. 1 is shown as a segmentation inference map image.

The image classification models attempt to classify images into a single category, usually corresponding to the most salient object. Photos and videos are usually complex and contain multiple objects which can make label assignment with image classification models tricky and uncertain. Often, object detection models can be more appropriate to identify multiple relevant objects in a single image. Additionally, object detection models can provide localization of objects.

Traditionally, models utilized to perform image classification, object detection, and instance segmentation included, but were not limited to, Region-based Convolutional Neural Network (R-CNN), Fast Region-based Convolutional Neural Network (Fast R-CNN), Faster Region-based Convolutional Neural Network (Faster R-CNN), Region-based Fully Convolutional Neural Network (R-FCN), You Only Look Once (YOLO), Single-Shot Detector (SSD), Neural Architecture Search Net (NASNet), and Mask Region-based Convolutional Network (Mask R-CNN). While embodiments of the disclosure utilize feature pyramid network models to generate prediction data, certain embodiments can utilize one of the above methods during either the bottom-up or top-down processes based on the needs of the particular application.

In many embodiments, models utilized by the present disclosure can be calibrated during manufacture, development, and/or deployment. Calibration typically involves the use of one or more training sets which may include, but are not limited to, PASCAL Visual Object Classification and Common Objects in Context datasets.

Additionally, it is contemplated that multiple models, modes, and hardware/software combinations may be deployed within the asynchronous neural network system and that the system may select from one of a plurality of neural network models, modes, and/or hardware/software combinations based upon the determined best choice generated from processing input variables such as input data and environmental variables. In fact, embodiments of the present disclosure can be configured to switch between multiple configurations of the asynchronous neural network as needed based on the application desired and/or configured. For example, U.S. patent application titled “Object Detection Using Multiple Neural Network Configurations”, filed on Feb. 27, 2020 and assigned application Ser. No. 16/803,851 (the '851 application) to Wu et al. discloses deploying various configurations of neural network software and hardware to operate at a more optimal mode given the current circumstances. These decisions on switching modes may be made by a controller gathering data to generate decisions. The disclosure of the '851 application is hereby incorporated by reference in its entirety, especially as it pertains to generating decisions to changes modes of operations based on gathered input data.

Referring to FIG. 8, a conceptual diagram of an asynchronous neural network system in accordance with an embodiment of the disclosure is shown. In many embodiments, the asynchronous neural network system 800 comprises at least a neural network 810 and an inference frequency controller 820. A series of input images 115 are utilized as data inputs that are passed to the neural network 810 for processing. In a variety of embodiments, an input image 115 can also be passed into the inference frequency controller 820 for analysis in determining one or more potential processing frequencies within the neural network 810.

In a number of embodiments, the neural network 810 utilizes a feature pyramid network such as those described in the discussion of FIG. 6. Without input from the inference frequency controller, the neural network 810 can often operate as a traditional neural network and process the input image 115 to generate designated output(s) 850. However, as previously discussed, the neural network 810 of the asynchronous neural network system 800 can be configured to process different stages of the neural network 810 at varying frequencies 811, 812, 813.

By way of illustrative example, the neural network 810 depicted in FIG. 8 comprises a feature pyramid network with multiple stages that correspond to a particular convolution step within the bottom-up pathway and a corresponding upsampling step within the top-down pathway. Stage 1 indicates a convolution at the end of the bottom-up pathway matched with an initial upsampling process. Conversely, Stage 3 comprises an input feature map and associated data generated at the beginning of the bottom-up pathway corresponding with the last upsampling steps within the top-down pathway process. Similarly, Stage 2 comprises convolution and upsampling steps that are in the middle of each pathway. Each stage within the neural network 810 can be configured to operate at a different frequency compared to neighboring stages. The determination of what frequency to operate each stage on is made within the inference frequency controller 820 and communicated to the neural network 810 via one or more frequency signals which are formatted to contain frequency signal data.

Previously, it was discussed that the inference frequency controller 820 is configured in many embodiments to receive the input image 115 for processing to determine potential changes in processing frequency. The input image 115 may be processed or otherwise evaluated to determine suitability for a potential decrease in processing frequency. Specifically, with video content input, analysis can be performed to determine various factors including, but not limited to, image dimensional depth, similarity to previously processed frames, and/or image format. However, as shown in FIG. 8, the inference frequency controller 820 can be configured to receive input data from additional sources including, but not limited to, environmental variables 830, and output(s) 850.

Environmental variables can include any external data set that may be formatted for evaluation. As depicted in FIG. 8, these variables may include, but are not limited to, CPU (or general computational) power available, the current frequencies being utilized within the neural network 810, temperature (which may include overall ambient temperature, or specific device temperature), available memory (or potential bottlenecks with other applications/processes), and/or the amount of remaining power available. The inference frequency controller 820 can utilize any of the plurality of environmental variables 830 to determine if the frequency of any stage within the neural network 810 should be adjusted. For example, as decreasing the frequency of one or more stages within the neural network 810 requires fewer processing steps, generating frequency signal data to lower one or more stages may occur when environmental variables indicate that limited power within the host-computing device is available, or that available CPU power is generally limited. When measured temperatures get too hot, decreasing the processing frequency within the neural network 810 may also help to lower temperatures within the host-computing device as fewer calculations are needed.

Evaluation of environmental variables 830, as well as input image(s) 115 may occur by comparing the determined inputs to one or more threshold values. As those skilled in the art will recognize, the threshold values utilized may be preconfigured as a set of defined values. However, in some embodiments, the threshold values can be dynamically generated based on a mixture of one or more environmental variables. By way of example and not limitation, a combination of low available power, and low available computing resources may generate a lower threshold for the triggering of a decrease in neural network 810 processing frequency. Likewise, the dynamically generated threshold values may be generated based on the type of input image 115 presented. In these embodiments, a determination of an input image 115 that can easily be processed may change the threshold value compared against the one or more environmental variables 830.

Finally, the output(s) 850 of the neural network 810 may be input back into the inference frequency controller 820 to evaluate the quality of the output(s) 850. In various embodiments, an asynchronous neural network system 800 may generate incorrect or “noisy” output(s) 850 when the frequency of one or more stages within the neural network 810 has been reduced too much. Therefore, the inference frequency controller 820 may evaluate the output(s) 850 for one or more abnormalities within the output(s) 850. In the example of video content processing, the neural network 810 may be processing input images 115 to generate instance segmentation map images as seen in FIG. 1, As an object is tracked across multiple frames, it is expected that an amount of smooth movement will be present and detected. However, if the inference frequency controller 820 detects one or more abnormalities such as jerky or overly coarse movement between multiple frames, a determination can be made to increase the amount of frequency processing to avoid future abnormalities.

Once the inference frequency controller 820 has generated and transmitted a frequency signal to the neural network 810 to reduce the processing frequency in one or more stages, feature map data will need to be reused. Specifically, as upsamplings associated with subsequent input images will still need feature map data to generate spatially accurate data. When a uniform frequency between all stages is present, the feature map data of an input image 115 will be immediately available to any stage within the upsampling pathway as each feature map was just generated prior during the convolution pathway processing. However, when the frequency of processing one or more stages is reduced, the convolution process within the bottom-up pathway will not complete at every step, leaving one or more (usually associated) steps within the upsampling process without lateral connection input data. In these embodiments, this problem can be overcome by utilizing the last feature map data that was processed with that stage of the convolution pathway.

For example, a first stage is configured to operate at a normal base frequency, while a second stage is configured to process only every other frame. In this example, the corresponding second upsampling step within the top-down pathway would utilize the feature map data generated by the previous input frame. In order to utilize and recall this feature map data, a saved feature map cache 840 can be utilized to store and provide upon request a plurality of previously generated feature maps within the neural network 810. In various embodiments, the saved feature map cache 840 can be accessed directly by the neural network 810 instead of accessing the lateral connection from a corresponding convulsion layer. It is contemplated that feature map data may be stored within the saved feature map cache 840 for as long as it may be needed. In fact, in certain embodiments, the inference frequency controller 820 may configure one or more stages within the neural network to stop operating (effectively making their frequency zero) until a subsequent frequency signal is received from the inference frequency controller 820. In these cases, the feature map data will be stored within the saved feature map cache 840. An example of a host-computing system that can operate an asynchronous neural network system 800 is shown in more detail.

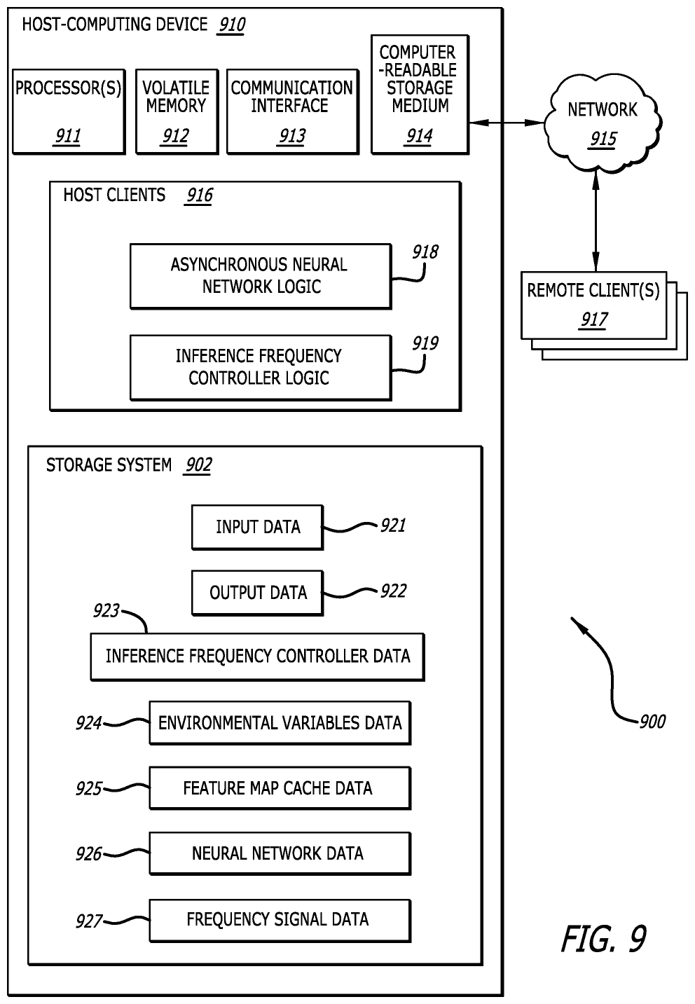

Referring to FIG. 9, a schematic block diagram of a host-computing device 910 capable of utilizing asynchronous neural networks in accordance with an embodiment of the disclosure is shown. The asynchronous neural network system 900 comprises one or more host clients 916 paired with one or more storage systems 902. The host-computing device 910 may include a processor 911, volatile memory 912, and a communication interface 913. The processor 911 may include one or more central processing units, one or more general-purpose processors, one or more application-specific processors, one or more virtual processors (e.g., the host-computing device 910 may be a virtual machine operating within a host), one or more processor cores, or the like. The communication interface 913 may include one or more network interfaces configured to communicatively couple the host-computing device 910 and/or the storage system 902 to a communication network 915, such as an Internet Protocol (IP) network, a Storage Area Network (SAN), wireless network, wired network, or the like.

The storage system 902, in various embodiments, can include one or more storage devices and may be disposed in one or more different locations relative to the host-computing device 910. The storage system 902 may be integrated with and/or mounted on a motherboard of the host-computing device 910, installed in a port and/or slot of the host-computing device 910, installed on a different host-computing device 910 and/or a dedicated storage appliance on the network 915, in communication with the host-computing device 910 over an external bus (e.g., an external hard drive), or the like.

The storage system 902, in one embodiment, may be disposed on a memory bus of a processor 911 (e.g., on the same memory bus as the volatile memory 912, on a different memory bus from the volatile memory 912, in place of the volatile memory 912, or the like). In a further embodiment, the storage system 902 may be disposed on a peripheral bus of the host-computing device 910, such as a peripheral component interconnect express (PCI Express or PCIe) bus such, as but not limited to a NVM Express (NVMe) interface, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCIe Advanced Switching (PCIe-AS) bus, or the like. In another embodiment, the storage system 902 may be disposed on a data network 915, such as an Ethernet network, an Infiniband network, SCSI RDMA over a network 915, a storage area network (SAN), a local area network (LAN), a wide area network (WAN) such as the Internet, another wired and/or wireless network 915, or the like.

The host-computing device 910 may further comprise a computer-readable storage medium 914. The computer-readable storage medium 914 may comprise executable instructions configured to cause the host-computing device 910 (e.g., processor 911) to perform steps of one or more of the methods or logics disclosed herein. Additionally, or in the alternative, the asynchronous neural network logic 918 and/or the inference frequency controller logic 919 may be embodied as one or more computer-readable instructions stored on the computer-readable storage medium 914.

The host clients 916 may include local clients operating on the host-computing device 910 and/or remote clients 917 accessible via the network 915 and/or communication interface 913. The host clients 916 may include, but are not limited to: operating systems, file systems, database applications, server applications, kernel-level processes, user-level processes, and the depicted asynchronous neural network logic 918 and inference frequency controller logic 919. The communication interface 913 may comprise one or more network interfaces configured to communicatively couple the host-computing device 910 to a network 915 and/or to one or more remote clients 917.

Although FIG. 9 depicts a single storage system 902, the disclosure is not limited in this regard and could be adapted to incorporate any number of storage systems 902. The storage system 902 of the embodiment depicted in FIG. 9 includes input data 921, output data 922, inference frequency controller data 923, environmental variables data 924, feature map cache data 925, neural network data 926, and frequency signal data 927. These data 921-927 can be utilized by one or both of the asynchronous neural network logic 918, and the inference frequency controller logic 919.

In many embodiments, the asynchronous neural network logic 918 can direct the processor(s) 911 of the host-computing system 910 to generate one or more multi-stage neural networks, utilizing neural network data 926 which can store various types of neural network models, weights, and various inputs and outputs configurations. The asynchronous neural network logic can further direct the host-computing system 910 to establish one or more input and output pathways for data transmission. Input data transmission can utilize input data 921 which is typically any time-series data. However, as discussed previously, many embodiments utilize video content as a source of input data 921, even if there is no limitation on that data format.

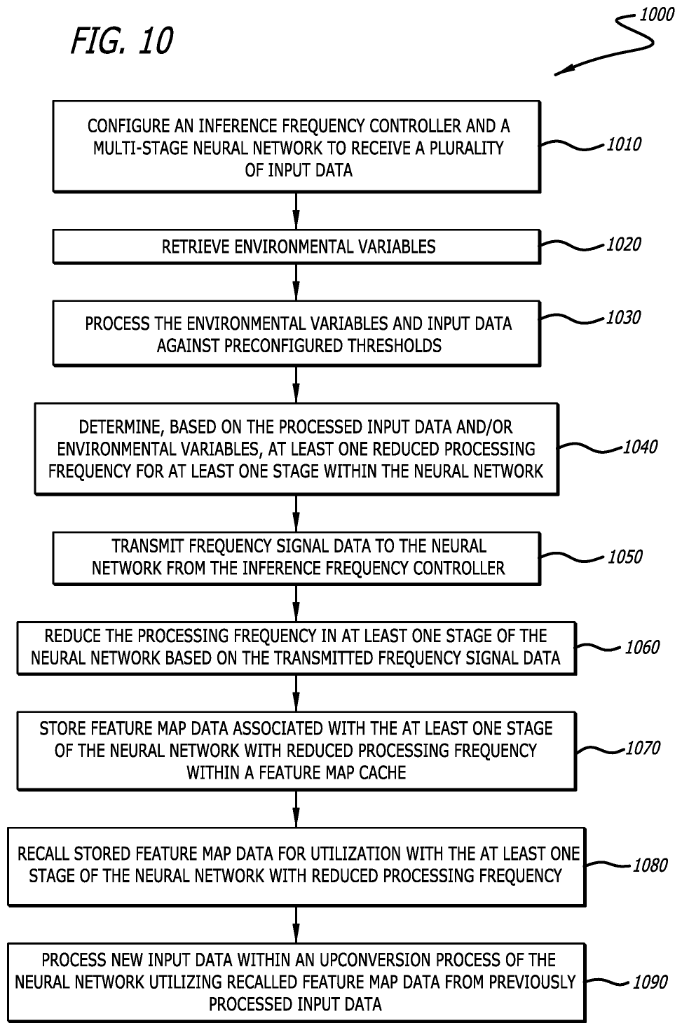

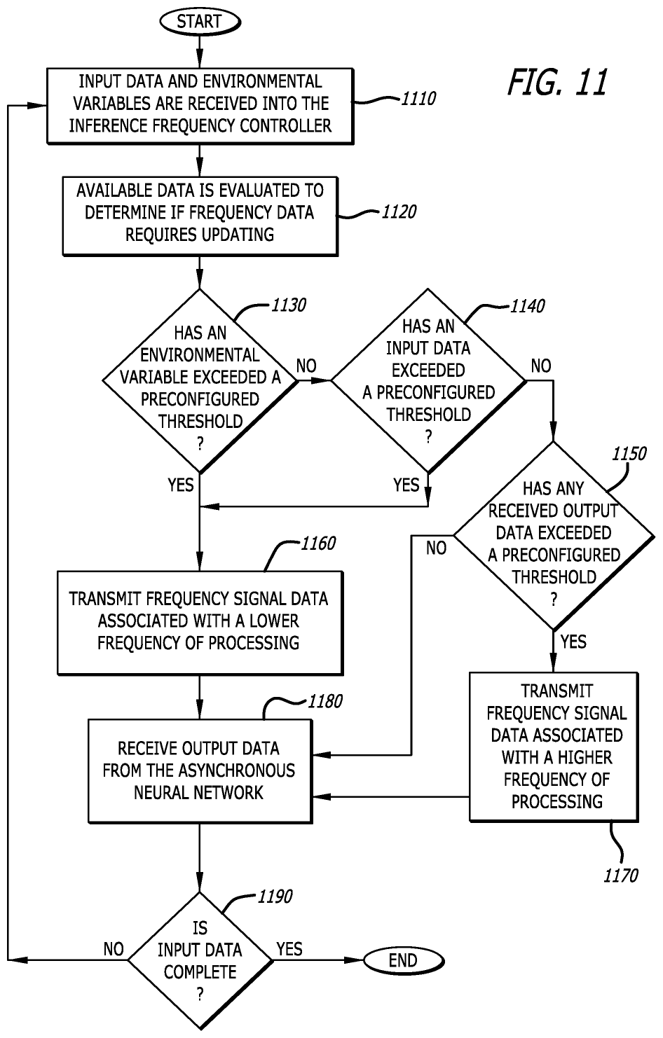

The asynchronous neural network logic 918 can also direct the processor(s) 911 to call, instantiate, or otherwise utilize an inference frequency controller logic 919. From the inference frequency controller logic 919, inference frequency controller data 923 can be utilized to begin the process of evaluating incoming input data to generate one or more frequency signals that will direct the asynchronous neural network logic 918 to change the frequency of processing at least one of its neural network layers. This generation of frequency signal data 927 is outlined in more detail in the discussion of FIGS. 10 and 11. However, in a variety of embodiments, the inference frequency controller logic 919 retrieves environmental variables data 924, input data 921, and/or output data 922 to determine if frequency signal data 927 should be generated and subsequently passed on to the asynchronous neural network logic 918.

When the asynchronous neural network logic 918 is directed by receiving frequency signal data 927 to reduce the processing frequency of at least one stage within its neural networks, feature map cache data 925 is generated and stored within the storage system 902. To reduce computational complexity, the asynchronous neural network logic 918 can retrieve and utilize the feature map cache data 925 as input within at least one stage of the multi-stage asynchronous neural network. Once the processing of the input data 921 is completed by the asynchronous neural network, output data 922 can be stored within the storage system 902. The output data 922 can then be passed on as input data to the inference frequency logic 919 but may also be formatted and utilized in any of a variety of locations and uses within the host-computing system 910.

Referring to FIG. 10, a flowchart depicting a process 1000 for utilizing a feature map data cache in an asynchronous neural network system in accordance with an embodiment of the disclosure is shown. In many embodiments, the process 1000 requires that a multi-stage neural network and inference frequency controller be configured to receive a plurality of input data (block 1010). In various embodiments, the input data can be video content, although any time-series data can be utilized. External environmental variables are subsequently retrieved (block 1020). Environmental variables can be any set of data that may affect the potential to change the frequency of processing various stages within the neural network. As discussed above, environmental variables can include, but are not limited to, computational power, available memory/storage space, power reserves available, temperature, and current network status. Once input data and the environmental variables have been gathered, they can be processed within the inference frequency controller against a plurality of preconfigured thresholds (block 1030). In some embodiments, the evaluated thresholds may include dynamically generated thresholds based on various input factors including the previously received data.

Based on the evaluation done against the preconfigured thresholds, the process 1000 can determine that at least one stage within the neural network can have its processing frequency reduced (block 1040). Once determined, the inference frequency controller can generate and transmit frequency signal data to the neural network (block 1050). Upon receipt of the frequency signal data, at least one stage within the neural network processes input images at a lower frequency (block 1060). Processing of the input data continues within the neural network however, and lateral connection inputs within one or more stages expect feature map input that would otherwise be generated from the reduced frequency stage.

To solve this problem, the process 1000 can first determine the previous feature map output data generated by the newly frequency reduced stage within the neural network. This feature map data can be stored with a feature map cache for future use (block 1070). Subsequently, when the next input data set is being processed, the neural network can, instead of processing the new image again within the reduced frequency stages of the neural network, recall the stored feature map data from that stage and utilize it as input again (block 1080). This recalled feature map data is passed into an upsampling process within the neural net as a lateral connection input associated with the same stage of the process (block 1090). The accessing of stored feature map data is less computationally taxing than processing a subsequent image through the convolution process of the multi-stage neural network. Thus, reduced processing overhead is required to generate output data within the asynchronous neural network that is often semantically similar to a traditional neural network.

Referring to FIG. 11, a flowchart depicting the processing of input data by an inference frequency controller within an asynchronous neural network in accordance with an embodiment of the disclosure is shown. This process can be applied to any standard neural network that processes time-series data and utilizes one or more lateral connections within the neural network. The process can start when input data and environmental variables are received into the inference frequency controller (block 1110). Once received, the available data is evaluated to determine if frequency data requires updating (block 1120). As described below, the data may be evaluated against a series of threshold variables to determine whether the frequency of processing within the neural network should be either increased or decreased. Although the process depicted within FIG. 11 shows a fixed number of threshold variables examined in a specific order, it is contemplated that other variable types may be evaluated and the order of the evaluation can be changed based on the required application.

The process can evaluate whether an environmental variable exceeded a preconfigured (i.e. pre-determined) threshold (block 1130). Environmental thresholds can include any external data and are described in more detail in the discussion of FIG. 8. If an environmental variable exceeds a preconfigured threshold, the inference frequency controller can transmit frequency signal data associated with a lower frequency of processing (block 1160). In other words, data is transmitted from the inference frequency controller to the neural network that instructs one or more of the stages within the neural network to reduce the frequency of processing incoming data. When no environmental variables exceed a preconfigured threshold, the process can evaluate if the input data exceeded a preconfigured threshold (block 1140). As discussed above with respect to FIG. 8, various types of input data can be formatted as better or worse suited to allow reduced frequency in processing. For example, video content input with little movement would be better suited for a reduced processing frequency compared to fast-moving and quickly edited video content. Therefore, qualities that affect such evaluations can be quantified and evaluated with respect to a threshold to determine if a reduced processing frequency can be utilized in the current input data. When a particular input data threshold is exceeded, the inference frequency controller can transmit a signal to the neural network to reduce processing in at least one stage (block 1160).

When the input data has not exceeded a threshold value, the process can evaluate if a received output data has exceeded a preconfigured threshold (block 1150). As discussed above with respect to FIG. 8, certain time-series data can exhibit certain abnormalities if the processing frequency of one or more stages within the neural network have been reduced too much. Therefore, if the received output data is evaluated to exceed a preconfigured threshold, the inference frequency controller can transmit frequency signal data to the neural network to increase the processing frequency of one or more stages within the neural network (block 1170). When the output data does not exceed any preconfigured threshold, the process can continue to receive output data from the asynchronous neural network (block 1180) before moving on.

Once the inference frequency calculator has transmitted frequency data to the neural network to either increase (block 1170) or decrease (block 1160) the processing frequency of one or more stages, the processing of the inference frequency controller can proceed to receive the output data from the asynchronous neural network (block 1180). Once the output has been received, an evaluation can be made to determine if all of the input data has been processed (block 1190). When processing of all the input data has completed, the process ends. Alternatively, if more input data remains to be processed, the inference frequency controller can return to gather and receive the next relevant input data and environmental variables (block 1110).

Although the above evaluations within the embodiment of FIG. 11 occur exclusively and within a series, it is contemplated that other embodiments can process these variables and data against thresholds in various orders, mutually together, or in parallel. Indeed, additional evaluations may occur based on additional data that may indicate that the frequency processing speed within one or more stages of the neural network could be changed. Furthermore, although the embodiment depicted in FIG. 11 discusses evaluating data against preconfigured thresholds, embodiments are considered that utilizes dynamically generated thresholds, wherein the dynamic generation can occur per input data set, per atomic piece of input data, and/or per evaluation (meaning a first evaluation may change the threshold values of a second evaluation). These types of dynamic thresholds are described in more detail above with reference to FIG. 8.

Information as herein shown and described in detail is fully capable of attaining the presently described embodiments of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device comprising:
a processor configured to execute a neural network, the neural network being configured to receive a set of time-series data for processing and further comprising:
a multi-step convolution pathway comprising a plurality of steps, wherein the output of at least one step of the plurality of steps comprises one or more feature maps; and
a multi-step upsampling pathway wherein a plurality of steps have a corresponding convolution step input;
wherein, in response to receiving a set of time-series data, feature map data from at least one step of the multi-step convolution pathway is utilized as input data in at least one corresponding step of the multi-step upsampling pathway; and
an inference frequency controller configured to:
receive input data; and
transmit an output signal based on the received input data to the neural network;
wherein the neural network is further configured to, in response to receiving the output signal from the inference frequency controller, generate feature maps at fewer than every step within the multi-step convolution pathway, and utilize previously processed feature maps as input data within at least one step within the multi-step upsampling pathway until a subsequent feature map is generated.

2. The device of claim 1, wherein the transmitted output signal of the inference frequency controller is generated based on the received input data.

3. The device of claim 1, wherein the device further comprises a data cache configured to store feature map data.

4. The device of claim 3, wherein the data cache is further configured to provide the stored feature map data to the neural network for processing as an alternative to generating new feature map data.

5. The device of claim 4, wherein the neural network is further configured to additionally output generated feature map data to the data cache, the data cache storing the feature map data until requested by the neural network or replaced by subsequently generated feature map data.

6. A device, comprising:
a processor configured to execute a neural network, the neural network being configured to process a series of images, and further comprising:
a first multi-step processing pathway; and
a second multi-step processing pathway wherein a plurality of steps within the second multi-step processing pathway comprises at least:
an input from a previous step within the second multi-step processing pathway;
an input from the first multi-step processing pathway; and
an output configured to generate inferences; and
an inference frequency controller configured to modulate the neural network processing in at least one step within the first multi-step processing pathway.

7. The device of claim 6, wherein the first multi-step processing pathway generates output data that is passed as in input into a corresponding step within the second multi-step processing pathway.

8. The device of claim 7, wherein each step within the first multi-step processing pathway and the corresponding step from within the second multi-step processing pathway are grouped as a stage.

9. The device of claim 8, wherein the modulation includes reducing the processing in at least one stage of the neural network.

10. The device of claim 6, wherein the second multi-step processing pathway is a upsampling pathway.

11. The device of claim 10, wherein the output of the upsampling pathway comprises a plurality of inferences.

12. The device of claim 6, wherein the first multi-step processing pathway is a convolution pathway.

13. The device of claim 12, wherein the output of the convolution pathway is feature map data.

14. The device of claim 13 wherein the inference frequency controller is further configured to direct the neural network to generate less feature map data per frame by skipping one or more steps within the convolution pathway.

15. The device of claim 14, wherein, when directed to generate less feature map data, the neural network is further configured to utilize previously generated feature map data associated with a similar step within the convolution pathway.

16. The device of claim 15, wherein the previously generated feature map data is retrieved from a feature map data cache within the device.

17. The device of claim 16, wherein the retrieved feature map data is utilized for a number of processes specified by the inference frequency controller.

18. The device of claim 16, wherein the inference frequency controller is further configured to direct multiple stages within the neural network to operate at different frequencies.

19. The device of claim 16, wherein the inference frequency controller is further configured to receive computing resources data as input data.

20. The device of claim 16, wherein the inference frequency controller is further configured to receive environmental variables data as input data.

21. The device of claim 20, wherein the environmental variables received by the inference frequency controller include local thermal data.

22. The device of claim 21, wherein the inference frequency controller is further configured to modulate the neural network processing based on received local thermal data exceeding a preconfigured threshold.

23. A method, comprising:
configuring a neural network to receive a series of images to generate prediction data;
establishing a multi-step convolution pathway within the neural network;
establishing a multi-step upsampling pathway within the neural network wherein a plurality of upsampling steps comprise an input to receive output data from a corresponding convolution pathway step;
wherein, in response to receiving image for processing, feature map output data is generated at a plurality of steps within the convolution pathway, and at least one step of the upsampling pathway utilizes at least the received feature map data to generate prediction data;
configuring an inference frequency controller to provide an output signal to the neural network; and
configuring the neural network to, in response to receiving the output signal from the inference frequency controller, generate feature map data at fewer than every step within the multi-step convolution pathway and previously processed feature map data is utilized as input data within the multi-step upsampling pathway until a subsequent feature map input is received.

24. The method of 23, wherein, based on received time-series input data, the inference frequency controller is further configured to format the output signal to indicate which neural network type from a plurality of neural network types will be suitable for processing subsequent input data within the time-series.

25. A method comprising:
configuring an inference frequency controller to receive input data from a plurality of inputs;
processing the received input data;
determining a processing frequency for a neural network configured to process time-series data; and
transmitting a signal associated with the determined frequency to the neural network;
wherein the signal is configured to change the frequency of processing time-series data within the neural network.
